(19) United States
(12) Patent Application Publication
(10) Pub. No.: US 2005/0060290 A1
(43) Pub. Date: Mar. 17, 2005

(54) AUTOMATIC QUERY ROUTING AND RANK CONFIGURATION FOR SEARCH QUERIES IN AN INFORMATION RETRIEVAL SYSTEM

(75) Inventors: Michael Herscovici, Haifa (IL); Reiner Kraft, Gilroy, CA (US); Ronny Lempel, Haifa (IL); Jason Yeong Zien, Mountain View, CA (US)

Correspondence Address: LACASSE & ASSOCIATES, LLC, 1725 DUKE STREET, SUITE 650, ALEXANDRIA, VA, 22314, US

(73) Assignee: INTERNATIONAL BUSINESS MACHINES CORPORATION, Armonk, NY (US)

(21) Appl. No.: 10/605,208

(22) Filed: Sep. 15, 2003

(51) Int. Cl. G06F 17/30

(52) U.S. Cl. 707/3

(57) ABSTRACT

A query is received and parsed to generate a set of query terms. Statistical information is identified regarding each of the query terms and different permutations of the query terms. Additionally, lexical affinities associated with the permutations of query terms are identified. Next, the query is classified into a query category and a set of ranking parameters and routing information (associated with the query category) are identified. The query is then issued to a search engine by applying the identified ranking parameters and routing information, whereupon the search engine executes the query and forwards search results that can be accessed by an application using an API (e.g., the results can be viewed via a browser).

### BACKGROUND OF INVENTION

1. Field of the Invention

The present invention relates generally to the field of information retrieval. More specifically, the present invention is related to automatic query routing and rank configuration (for search queries) in an information retrieval system.

2. Discussion of Prior Art

Search engines use ranking to prioritize search results by relevancy (where relevancy can be defined by the user) so that the user is not overwhelmed with the task of having to skim through a myriad of possibly irrelevant matches. Examples of common ranking models include the Term Frequency-inverse Document Frequency (TF-IDF) ranking model (which is based upon weighting the relevance of a term to a document), the hyperlink-based ranking model (e.g., PageRankwhat_is_pageranktoptop which corresponds to a numeric value representing the importance of a pagewhat_is_pagerank, Hits), or a model that is a combination of the TF-IDF and the hyperlink-based model along with additional heuristics. The papers by Lan Huang entitled “A Survey on Web Information Retrieval Technologies” and Brin et al. entitled “The Anatomy of a Large-Scale Hypertextual Web Search Engine” provide for a general teaching in the area of information retrieval.

Within current Internet search technology ranking models, there exists a ranking function that takes a vector of parameters as an input to manipulate the overall scoring of a document given a query. Such a ranking function is often manually tuned using a small sample of test queries. Once a “good” set of ranking parameters is found, this set will be used to rank all queries.

Experiments show that, for certain queries, different ranking strategies and parameters produce better results. This can be verified if the expected result or truth set for a given query is known. However, one set of ranking parameters for query A may produce bad results for query B.

Furthermore, with search engines that have multiple (possibly overlapping) indices, it also makes a difference in the search quality as to where (which index) the query is routed. For instance, a search engine keeps a text index of all documents, and a separate anchor-text index (anchor text is the “highlighted clickable text” that is displayed for a hyperlink in a HTML page; for example, in the tag: <a href=“foo.html”>foo</a>, the anchor text is “foo” which is associated with the document “foo.html”) obtained by link analysis from these documents. Sending query A to the text index may produce the desired result, while sending query B to the text index may not produce good results at all.

The following references provide for a general teaching regarding information retrieval methods and systems.

The U.S. patent to Li (U.S. Pat. No. 5,920,859) provides for a hypertext document retrieval system and method. Disclosed is a typical search engine's structure that does anchor-text indexing wherein ranking is not query dependent. The search engine retrieves documents pertinent to a query and indexes them in accordance with hyperlinks pointing to those documents. An indexer traverses the hypertext database and finds hypertext information including the address of the document the hyperlinks point to and the anchor text of each hyperlink. The information is stored in an inverted index file, which may also be used to calculate document link vectors for each hyperlink pointing to a particular document. When a query is entered, the search engine finds all document vectors for documents having the query terms in their anchor text. A query vector is also calculated, and the dot product of the query vector and each document link vector is calculated. The dot products relating to a particular document are summed to determine the relevance ranking for each document.

The U.S. patent to Edlund (U.S. Pat. No. 6,546,388) provides for a metadata search results ranking system. The disclosed search engine system looks at query results that a user clicks on (and/or selects as being relevant) and adjusts relevance ranking of results of subsequent similar queries according to whether some search hits have been “popular” with previous users. The disclosed method comprises the steps of: coupling to a search engine a graphical user interface for accepting keyword search terms for searching the indexed list of information with the search engine; receiving one or more keyword search terms with one or more separation characters separating there-between; performing a keyword search with one or more keyword search terms received when a separation character is received; and presenting the number of documents matching the keyword search terms to the end-user via a graphical menu item on a display. The disclosed invention utilizes a combination of popularity and/or relevancy to determine a search ranking for a given search result association.

The non-patent literature to Kobayashi et al. entitled “Information Retrieval on the Web” relates to metasearch, wherein one search engine calls a number of others and then collates the results. After a query is issued, metasearchers work in three main steps: first, they evaluate which search engines are likely to yield valuable, fruitful responses to the query; next, they submit the query to search engines with high ratings; and finally, they merge the retrieved results from the different search engines used in the previous step. Since different search engines use different algorithms, some of which may not be publicly available, ranking the merged results may be a very difficult task. One way disclosed which may overcome this problem is the use of a result-merging condition by a metasearcher to decide how much data will be retrieved from each of the search engine results so that the top objects can be extracted from search engines without examining the entire contents of each candidate object. The disclosed software downloads and analyzes individual documents to take into account factors, such as: query term context, identification of dead pages and links, and identification of duplicate (and near duplicate) pages. Document ranking is based on the downloaded document itself instead of rankings from individual search engines.

To avoid a pitfalls associated with the prior art, an automatic approach is needed for deciding what set of ranking parameters should be used for a given query. Furthermore, a system is needed that dynamically identifies which set of indices a query should be sent to. Also, what is needed are query-dependent reliable heuristics that determine the best routing and ranking parameters required to optimize the precision of the retrieval process. Whatever the precise merits, features, and advantages of the above-cited references, they fail to achieve or fulfill the purposes of the present invention.

### SUMMARY OF INVENTION

A method for identifying documents most relevant to a query from a collection of documents that are organized based on a set of indices, the method comprising: (a) determining a query class for the query, the query class associated with a routing function and a ranking function, the routing function capable of determining subsets of the collection that most likely include the most relevant documents and the ranking function capable of sorting the documents in terms of relevancy; (b) determining the indices that are most relevant to the query; (c) identifying a set of documents related to the query based on the determined indices by passing a ranking function associated with the determined query class along with the query to each search engine that manages a determined index from a collection of relevant indices; and (d) collecting ranked results, merging and sorting the results by relevancy, and returning a subset of the highest ranked documents as the documents most relevant to the query.

In one embodiment, the method of the present invention comprises the steps of: (a) receiving a query; (b) parsing the query and generating a set of query terms; (c) identifying statistical information regarding each of the query terms and different permutations of query terms; (d) identifying lexical affinities (i.e., terms that appear close to each other within a certain range) associated with the permutations of query terms; (e) classifying the query into a query category based upon results of steps (c) and (d); (f) identifying a set of ranking parameters associated with the query category; (g) identifying routing information associated with the query category; (h) issuing a query to a search engine by applying the identified ranking parameters and the identified routing information; and (i) receiving and rendering search results from the search engine.

### BRIEF DESCRIPTION OF DRAWINGS

FIGS. 1a-b collectively illustrate a method associated with the present invention.

FIG. 2 illustrates another method in accordance with the present invention.

FIG. 3 illustrates additional steps associated with block 202 of FIG. 2.

FIG. 4 illustrates additional steps associated with block 206 of FIG. 2.

FIG. 5 illustrates additional steps associated with block 208 of FIG. 2.

### DETAILED DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered an exemplification of the principles of the invention and the associated functional specifications for its construction and is not intended to limit the invention to the embodiment illustrated. Those skilled in the art will envision many other possible variations within the scope of the present invention.

The present invention's system and method first analyzes the query string, as the number of query terms is used as a first impression to determine the type of query. Then, the queries are classified into query types. In one embodiment, the queries are classified into either:

A) informational type queries (e.g., looking for a particular driver for a computer model); or

B) homepage finding (e.g., find homepage for IBM alphaworks).

It should be noted that the above-mentioned classification of queries is for illustration purposes only and should not be used to limit the scope of the invention.

It should be noted that the preferred embodiment discloses a broad case wherein only two query categories are described: one for navigational queries and one for information queries. However, in addition to classifying a query to a query category, a different methodology can be used to calculate a rank configuration. For example, the calculation of these parameters could also be done using a function which interpolates a value in between the query categories, which results in a more gradual selection of ranking parameters. For instance, this function could decide that a query is 30% navigational and 70% informational. The parameters would be calculated accordingly. This leads to a more fuzzy generation of ranking parameters. In this case, a query would have a probability associated with each query class. As an example, for three query classes A, B, and C, a query ‘q’ can have A:0.8, B:0.15, and C:0.05, where the sum of probabilities is always 1.

The present invention's system and method identifies statistical parameters associated with each index term and applies a simple probability model to the query terms. From this information, it is determined whether the query is of type “A” or type “B”. Furthermore, query log files are inspected to look for further query term statistics.

For each category A and B, a set of ranking parameters that produce optimal results is identified. A set of ranking parameters (a rank configuration) is set of values. One of them might be the name of the query engine used. That is, an index may have one or more associated query engines (each serving queries), with the rest of the ranking parameters being values that tune that query engine. For instance, a rank configuration might be

(QueryEngine1, p1, p2, p3)

Where QueryEngine1 is a query engine, and p1 to p3 are parameters (e.g., some threshold, coefficient for TF-IDF). It can be seen that different query engines represent different methods of scoring/ranking of search results. Also, for each query type category, identification is made with regard to which index to consult or what weights to associate with the results from different indices.

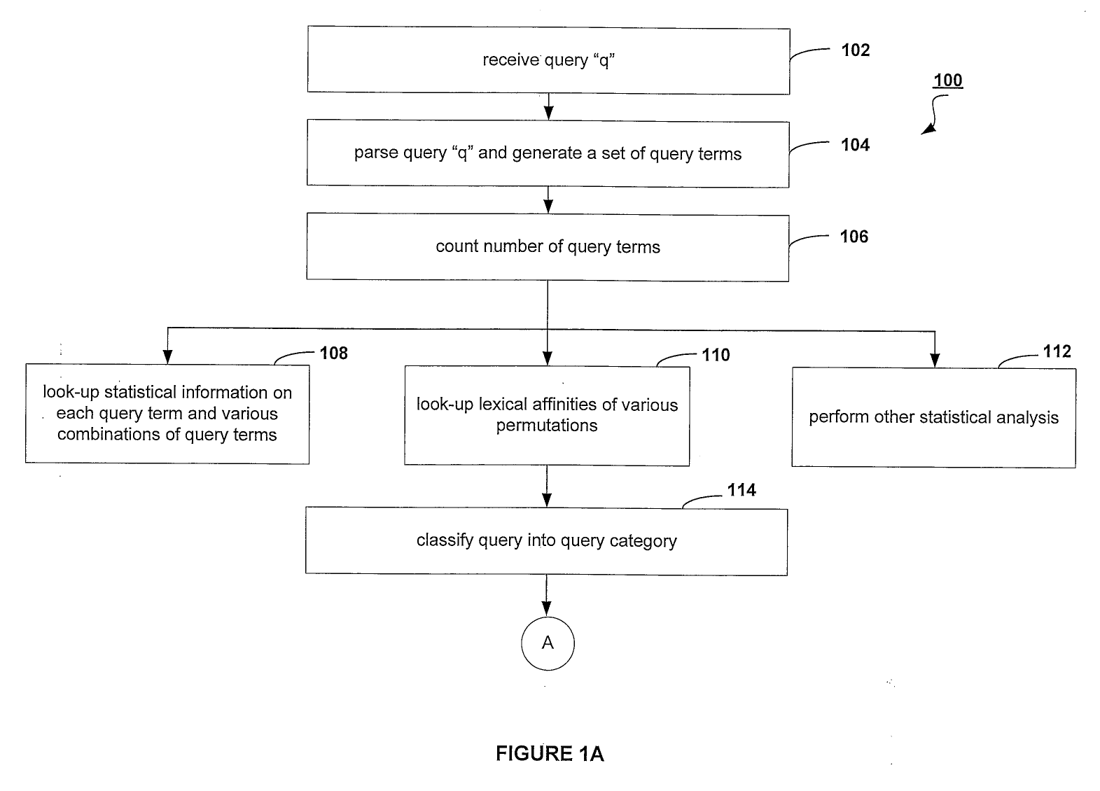

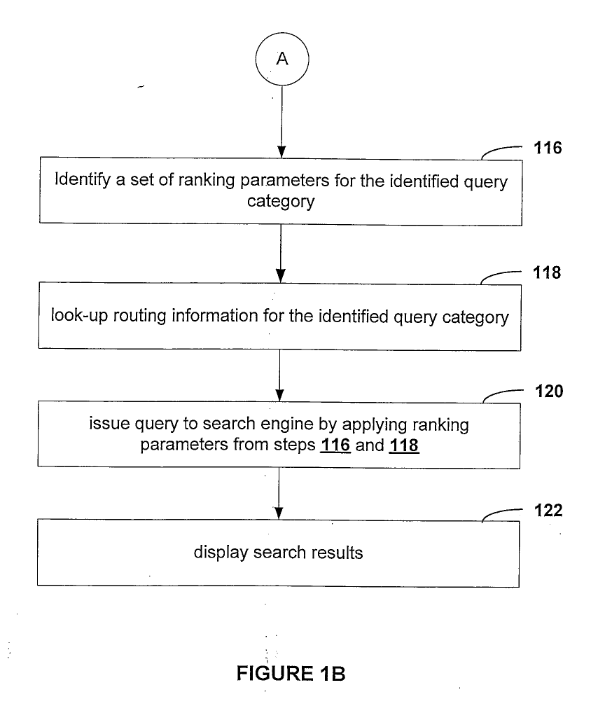

FIGS. 1a-b collectively illustrate an overview of a method 100 in accordance with the present invention. In step 102, a query “q” is received, which is then parsed, in step 104, to generate a set of query terms. In step 106, the number of query terms is identified.

Next, in step 108, statistical information regarding the query terms, and combinations (permutations) of these query terms, is identified from the index term statistics.

For example, the query term “a” appears on x different documents in the index. As another example, query term “a” appears on x different documents in the index, and query term “b” appears on “y” different documents; therefore, what is probability that both appear on the same document (i.e., P(ab))?

In step 110, lexical affinities of permutations of the above-mentioned query terms and their actual occurrence in the index are identified. For example, as P(ab) is only an approximation, a precise count in the form of lexical affinity statistics would be more accurate.

In step 112, other forms of analysis are performed such as, but not limited to, statistical analysis, log data analysis, or user feedback analysis.

Next, in step 114, based upon the results of steps 108, 110, and 112, the query is classified into an appropriate query category. In step 116, a set of ranking parameters is identified for that appropriate query category. Then, in step 118, routing information (index selection) for that query category is identified. Next, in step 120, a query is issued to a search engine by applying ranking parameters from step 116 and routing information from step 118. Further, in step 122, the search results from the search engine are rendered (via, for example, a browser).

In another embodiment, a classifier can be trained offline with a training set for higher accuracy. Hence, a set of sample queries can be used to define query categories and a classifier, implementing a learning algorithm, can then be used to learn from such examples. When such a classifier receives a new query, it generalizes based upon the learned examples and provides a suggestion. The learning algorithm can also make use of the statistical information (as described on earlier). Also, online learning algorithms or boosting algorithms (e.g., AdaBoost) can be applied to further extend the functionality of the present invention's system and method. For example, instead of having only two categories, “n” categories can be used. In the extreme case, if “n” is the number of queries, then each query has its own set of ranking parameters and routing information. In this embodiment, machine learning algorithms are combined with heuristics, whereby standard learning algorithms can be used in this context to learn a category.

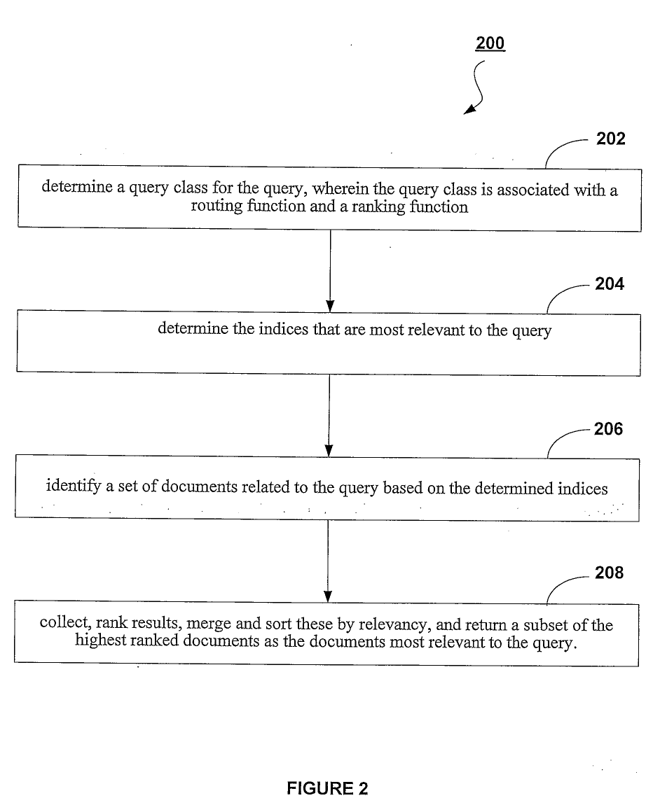

FIG. 2 illustrates another method 200 in accordance with the present invention. In step 202, a query class is determined for the query, wherein the query class is associated with a routing function and a ranking function. The routing function is capable of determining subsets of the collection that most likely include the most relevant documents, and the ranking function is capable of sorting the documents in terms of relevancy. In step 204, indices most relevant to the query are identified. In one embodiment, the routing information (obtained from applying the routing function of the query class that is associated to the search query) is used to determine the set of indices to use and consult during the retrieval process. Next, in step 206, a set of documents related to the query is identified based on the determined indices by passing a ranking function associated with the determined query class along with the query to each search engine that manages a determined index from a collection of relevant indices. Further, in step 208, ranked results are collected, merged, and sorted by relevancy, wherein a subset of the highest ranked documents is returned as the documents most relevant to the query.

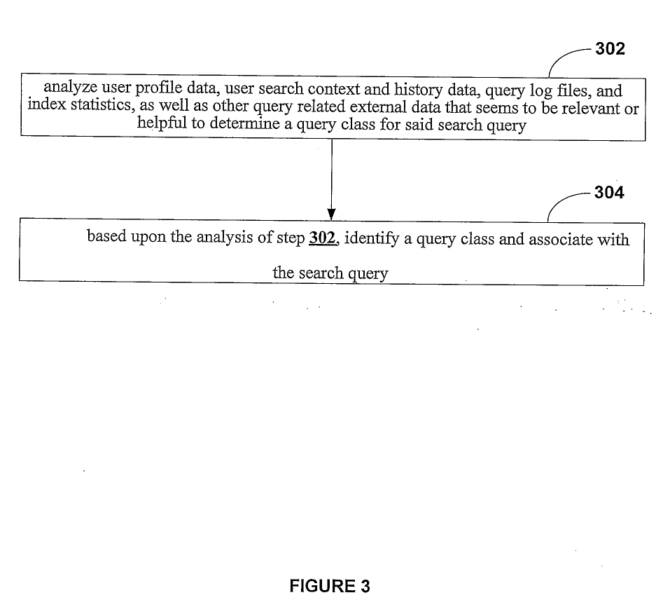

As shown in FIG. 3, step 202 of FIG. 2 further comprises the steps of: (a) analyzing user profile data, user search context and history data, query log files, index statistics, and other query-related external data that appear to be relevant in determining a query class for search query (step 302); and (b) identifying a query class (based upon the analysis in step (a) and associating the query class with the search query (step 304).

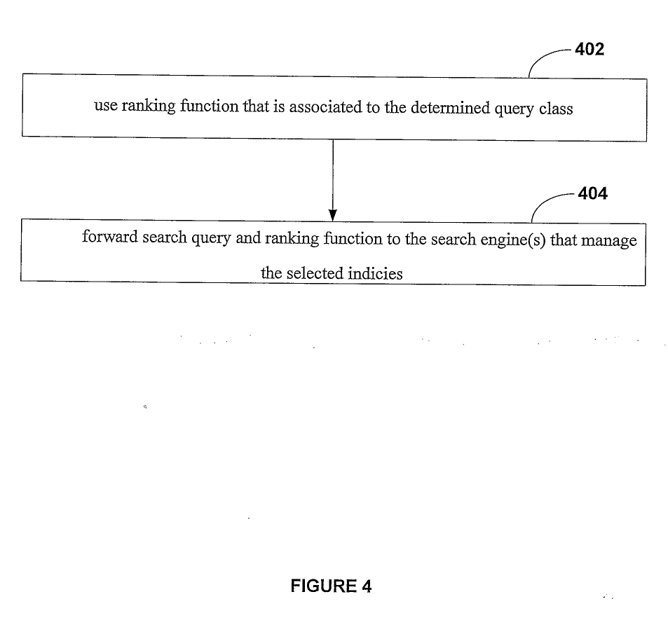

As shown in FIG. 4, step 206 of FIG. 2 further comprises the steps of: (a) using the ranking function that is associated with the determined query class (step 404); and

(b) forwarding the search query and ranking function of step 404 to the search engine(s) that manage the selected indices (from step 204 of FIG. 2).

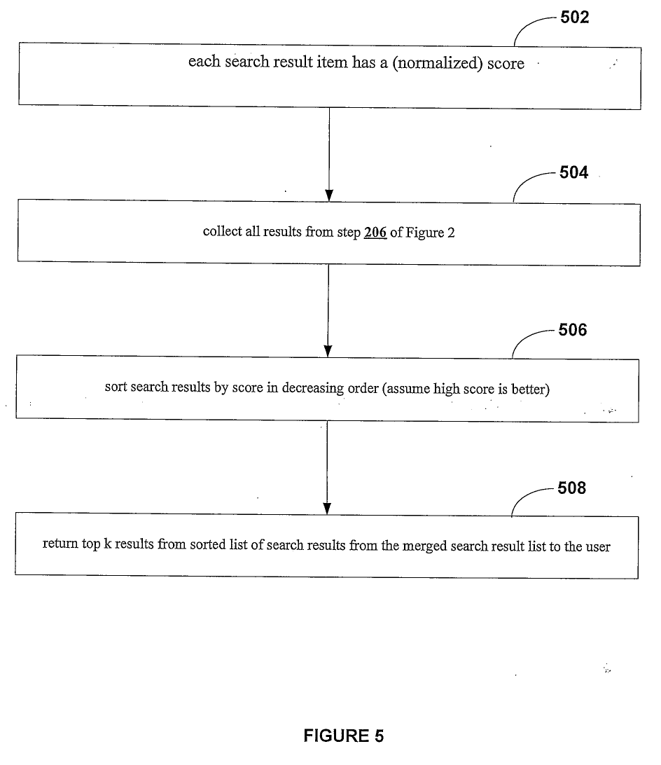

FIG. 5 illustrates additional steps associated with step 208 of FIG. 2. In step 502, each search result item is associated with a normalized score and, in step 504, all results from step 206 are collected. Next, in step 506, search results are sorted by score in decreasing order (for example, scores in ascending order with higher score being a better score). Further, in step 508, top “k” results are returned to the user from the sorted list of search results (from the merged search result list).

### EXAMPLE 1

query=“linux”

This is a one-term query. The index statistics show that the index term occurs on 70,000 documents (in an index of 3,000,000 documents). Furthermore, the log file provides evidence that the term is often used. The present invention, therefore, infers that this query is of type B, and then routes the query to the anchor text index first. Furthermore, it changes the rank parameters to boost static rank (which corresponds to a static, query-independent, quality value) factors such as, for example, Pagerank (which corresponds to a numeric value representing the importance of a page).

### EXAMPLE 2

query=“ibm search”

This is a two-term query. The index statistics show that the index term “ibm” occurs on 2,000,000 documents (in an index of 3,000,000 documents). The index term “search” occurs on 250,000 documents (in an index of 3,000,000 documents). The probability that both terms occur on the same document, therefore, is P(ibm*search)=(dococcurences(ibm)/3,000,000)*(dococcurences(search)/3,000,000)=0.05556. Another interesting statistical parameter is the product of P(ibm*search) and the number of documents, i.e., 0.05556*3,000,000=166,680.

Furthermore, the log file provides evidence that both terms are often used. There are 400,000 documents that contain the lexical affinity (“ibm search”), which is higher than the approximation based on the product of probability, P (ibm*search) and the number of documents.

The present invention, therefore, infers that this query is of type B and routes the query to the anchor text index first. Furthermore, it changes the rank parameters to boost static rank factors (e.g., Pagerank).

### EXAMPLE 3

query=v“setup and configure wireless adapter”

This is a very specific search request, and the index term statistics show that there are only few pages that contain that information. The present invention, therefore, classifies the query as type A (informational type) and routes the query to the text index and ignores the anchor text index completely. It de-emphasizes static ranks and focuses on classical information retrieval methodologies.

The invention increases the precision of Internet search engines and therefore enhances the overall search experience. Furthermore, the present invention includes a computer program code based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEP-ROM, EPROM, RAM, ROM, DRAM, SRAM, SDRAM, and/or any other appropriate static or dynamic memory or data storage device.

Implemented in computer program code-based products are software modules for: determining a query class for the query, said query class associated with a routing function and a ranking function, the routing function capable of determining subsets of the collection that most likely include the most relevant documents, and the ranking function capable of sorting the documents in terms of relevancy; determining indices most relevant to the query; identifying a set of documents related to the query based on the determined indices, wherein the identification performed via passing said ranking function associated with the determined query class along with the query to each search engine that manages a determined index from a collection of relevant indices; collecting results ranked based upon the ranking function and merging and sorting the collected results by relevancy; and returning a subset of the highest ranked documents as the documents most relevant to the query.

Conclusion

A system and method has been shown in the above embodiments for the effective implementation of an automatic query routing and rank configuration for search queries in an information retrieval system. While various preferred embodiments have been shown and described, it will be understood that there is no intent to limit the invention by such disclosure but, rather, it is intended to cover all modifications within the spirit and scope of the invention, as defined in the appended claims. For example, the present invention should not be limited by the number of categories, the type of category, type of ranking function, software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT), and/or hardcopy (i.e., printed) formats. The programming of the present invention may be implemented by one of skill in the art of information retrieval.

1. A method for identifying documents most relevant to a query from a collection of documents that is organized based on a set of indices, said method comprising the steps of:
a) determining a query class for the query, said query class associated with a routing function and a ranking function, said routing function capable of determining subsets of the collection that most likely include the most relevant documents, and said ranking function capable of sorting the documents in terms of relevancy;
b) identifying a set of indices most relevant to said query;
c) identifying a set of documents related to said query based on said determined indices, said identification performed via passing said ranking function associated with said determined query class along with said query to each search engine that manages a determined index from a collection of relevant indices;
d) collecting results ranked based upon said ranking function and merging and sorting said collected results by relevancy; and
e) returning a subset of the highest ranked documents as the documents most relevant to the query.

2. The method as per claim 1, wherein said step for determining a query class further comprises the following steps:
a) analyzing user profile data, user search context and history data, log file data, and index statistics, or other query related external data; and
b) utilizing said analyzed data in determining a query class for said search query.

3. The method as per claim 1, wherein said step for identifying a set of indices further comprises the step of using routing information obtained from applying said routing function associated with said query class to determine said set of indices.

4. The method as per claim 1, wherein said step of returning a subset of the highest ranked documents further comprises the following steps:
a) assigning each search result item a relevancy score; and
b) returning a predetermined subset of results from said search results.

5. The method as per claim 4, wherein said method additionally comprises the step of sorting search results by said relevancy score in decreasing order prior to returning said predetermined subset of results.

6. A method as per claim 1, wherein said method is implemented across networks.

7. A method as per claim 6, wherein said across networks element comprises any of, or a combination of, the following: wide area network (WAN), local area network (LAN), cellular, wireless, or the Internet.

8. An article of manufacture comprising a computer user medium having computer readable code embodied therein which identifies documents most relevant to a query from a collection of documents that is organized based on a set of indices, said medium comprising:
a) computer readable program code determining a query class for the query, said query class associated with a routing function and a ranking function, said routing function capable of determining subsets of the collection that most likely include the most relevant documents, and said ranking function capable of sorting the documents in terms of relevancy;
b) computer readable program code determining indices most relevant to said query;
c) computer readable program code identifying a set of documents related to said query based on said determined indices, said identification performed via passing said ranking function associated with said determined query class along with said query to each search engine that manages a determined index from a collection of relevant indices;
d) computer readable program code collecting results ranked based upon said ranking function and merging and sorting said collected results by relevancy; and
e) computer readable program code returning a subset of the highest ranked documents as the documents most relevant to the query.

9. An article of manufacture as per claim 8, wherein said computer readable program code determining a query class further comprises:
a) computer readable program code analyzing user profile data, user search context and history data, log file data, and index statistics, or other query related external data; and
b) computer readable program code utilizing said analyzed data in determining a query class for said search query.

10. An article of manufacture as per claim 8, wherein said computer readable program code identifying a set of indices further comprises computer readable program code using routing information obtained from applying said routing function associated with said query class to determine said set of indices.

11. An article of manufacture as per claim 8, wherein said computer readable program code returning a subset of the highest ranked documents further comprises:
a) computer readable program code assigning each search result item a normalized score;
b) computer readable program code sorting search results by score in decreasing order of said scores; and
d) computer readable program code returning a predetermined subset of results from said sorted list of search results.

12. A method for retrieving information comprising the steps of:
a) receiving a query;
b) parsing said query and generating a set of query terms;
c) identifying statistical information regarding each of said query terms and different permutations of query terms;
d) identifying lexical affinities associated with said permutations of query terms;
e) classifying said query into a query category based upon results of steps c and d;
f) identifying a set of ranking parameters associated with said query category;
g) identifying routing information associated with said query category;
h) issuing a query to a search engine by applying said identified ranking parameters and said identified routing information; and
i) receiving and rendering search results from said search engine.

13. A method as per claim 12, wherein said step of identifying statistical information additionally comprises the step of analyzing log data.

14. A method as per claim 12, wherein said step of identifying statistical information additionally comprises the step of analyzing user feedback.

15. A method as per claim 12, wherein said method is implemented across networks.

16. A method as per claim 15, wherein said across networks element comprises any of, or a combination of, the following: wide area network (WAN), local area network (LAN), cellular, wireless, or the Internet.

17. An article of manufacture comprising a computer user medium having computer readable code embodied therein for retrieving information comprising the steps of:
a) computer readable program code receiving a query;
b) computer readable program code parsing said query and generating a set of query terms;
c) computer readable program code identifying statistical information regarding each of said query terms and different permutations of query terms;
d) computer readable program code identifying lexical affinities associated with said permutations of query terms;
e) computer readable program code classifying said query into a query category based upon results of steps c and d;
f) computer readable program code identifying a set of ranking parameters associated with said query category;
g) computer readable program code identifying routing information associated with said query category;
h) computer readable program code issuing a query to a search engine by applying said identified ranking parameters and said identified routing information; and
i) computer readable program code receiving and rendering search results from said search engine.
